(19) United States
(12) Patent Application Publication
(10) Pub. No.: US 2014/0056422 A1
(43) Pub. Date: Feb. 27, 2014

(54) NOISE SUPPRESSION SYSTEM

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: SHI-CHAO WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/869,318

(22) Filed: Apr. 24, 2013

(30) Foreign Application Priority Data
Aug. 21, 2012 (CN) 2012102964515

(51) Int. Cl. H04M 1/19

(52) U.S. Cl. CPC H04M 1/19
USPC 379/392.01

(57) ABSTRACT

A noise suppression system is applicable to a first phone, to reduce noise received by a microphone of the first phone. The microphone receives sound signals with different frequencies and converts the sound signals to electrical signals. The noise suppression system includes a selection circuit, an amplifying circuit, and a processing circuit. The selection circuit selects special electrical signals with frequency between 65 hertz to 1.1 kilohertz from the electrical signals. The amplifying circuit amplifies the selected electrical signals. The processing circuit stores a first preset value and a second preset value less than the first preset value. If the value of the amplified electrical signal is greater than or equal to the first preset value, or less than or equal to the second preset value, the processing circuit outputs the amplified electrical signal.

### BACKGROUND

1. Technical Field

The present disclosure relates to a system to filter noise in a call.

2. Description of Related Art

When a user uses a phone in noise environment, there may be a lot of ambient noise. As a result, it is not easy for the user to communicate with the party at the other end of the line.

### BRIEF DESCRIPTION OF THE DRAWINGS

Many aspects of the embodiments can be better understood with reference to the following drawing. The components in the drawings are not necessarily drawn to scale, the emphasis instead being placed upon clearly illustrating the principles of the present embodiments. Moreover, in the drawings, like reference numerals designate corresponding parts throughout the view.

FIG. 1 is a block diagram of an embodiment of a noise suppression system, wherein the noise suppression system includes a frequency selection circuit, an amplifying circuit, and a processing circuit.

FIG. 2 is a circuit diagram of the frequency selection circuit and the amplifying circuit of FIG. 1.

FIG. 3 is a circuit diagram of the processing circuit of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

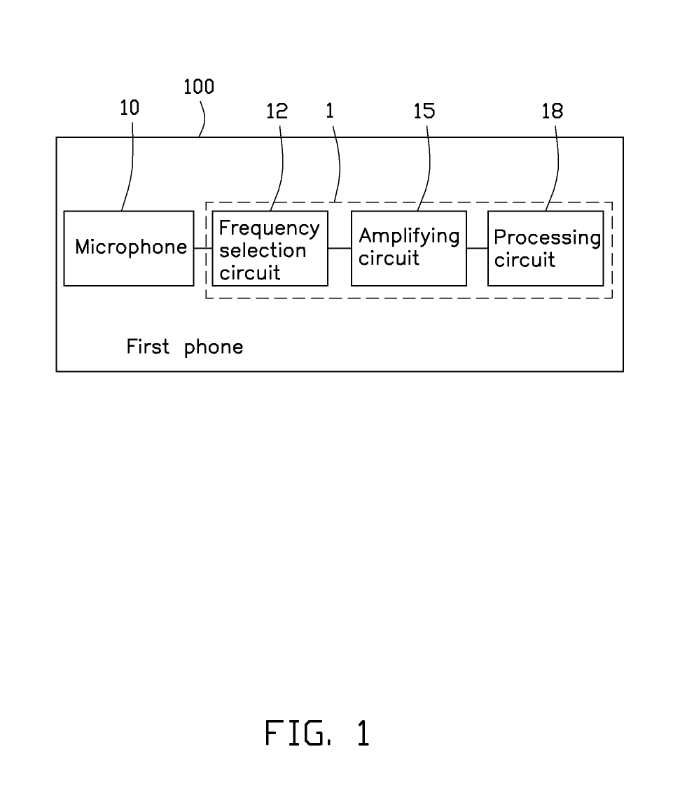

FIG. 1 shows an embodiment of a noise suppression system 1. The noise suppression system 1 can be used in a first phone 100, to reduce noise received by a microphone 10 of the first phone 100. The noise suppression system 1 includes a frequency selection circuit 12, an amplifying circuit 15, and a processing circuit 18.

In general, a human can hear sound frequency between 20 hertz (Hz) to 200 kilohertz (KHz), and a human can generate sound with frequency between 65 Hz-1.1 KHz. As a result, when the frequency of the sound generated by a human is less than 65 Hz or greater than 1.1 KHz, the sound is detected as noise.

The microphone 10 receives sound signals and converts the sound signals to electrical signals, and transmits the electrical signals to the frequency selection circuit 12. The frequency selection circuit 12 receives the electrical signals from the microphone 10 and selects the electrical signals corresponding to the sound signals with frequency between 65 Hz-1.1 KHz.

When a person is using the phone, the frequency of the sound signals received by the microphone 10 from the person is greater than the frequency of the sound signals received by the microphone 10 from a person standing nearby. However, if the nearby person is very close to the person who is using the phone, and a difference between the two frequencies of the sound signals of the person using the phone and the nearby person is insubstantial, the frequency selection circuit 12 outputs the selected electrical signals converted from the frequencies of the sound signals of the person using the phone and not the person near by the microphone 10 to the amplifying circuit 15. The amplifying circuit 15 amplifies the selected electrical signals and transmits the amplified electrical signals to the processing circuit 18.

The processing circuit 18 stores a first preset value and a second preset value. In one embodiment, the first preset value is 3.1 volts (V), and the second preset value is −3.1V. The processing circuit 18 receives the amplified electrical signals from the amplifying circuit 15 and compares the value of the amplified electrical signal with the first and second preset values. If the value of the amplified electrical signal is less than the first preset value, and the value of the amplified electrical signal is greater than the second preset value, the processing circuit 18 filters the amplified electrical signal. If the value of the amplified electrical signal is greater than or equal to the first preset value, or the value of the amplified electrical signal is less than or equal to the second preset value, the processing circuit 18 transmits the amplified electrical signal to a speaker 20 of a second phone 200 through a telephone line or a wireless network, which communicates with the first phone 100.

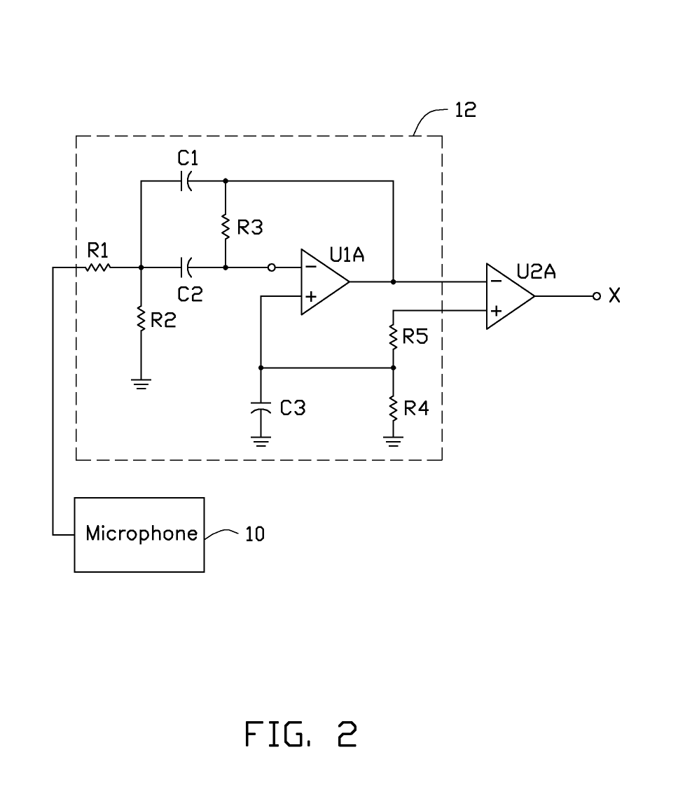

FIG. 2 shows that the frequency selection circuit 12 includes resistors R1-R5, capacitors C1-C3, and an amplifier U1A, the amplifying circuit 15 includes an amplifier U2A.

A first terminal of the resistor R1 is connected to the microphone 10. A second terminal of the resistor R1 is grounded through the resistor R2. The second terminal of the resistor R1 is connected to an inverting terminal of the amplifier U1A via the capacitor C1 and the resistor R3 in that order. In addition, the second terminal of the resistor R1 is connected to the inverting terminal of the amplifier U1A through the capacitor C2. A non-inverting terminal of the amplifier U1A is grounded through the capacitor C3. An output terminal of the amplifier U1A is connected to a node between the capacitor C1 and the resistor R3. The output terminal of the amplifier U1A is further connected to an inverting terminal of the amplifier U2A. A non-inverting terminal of the amplifier U2A is grounded through the resistors R5 and R4 in that order. A node between the resistors R5 and R4 is connected to the non-inverting terminal of the amplifier U1A. An output terminal of the amplifier U2A is connected to the processing circuit 18.

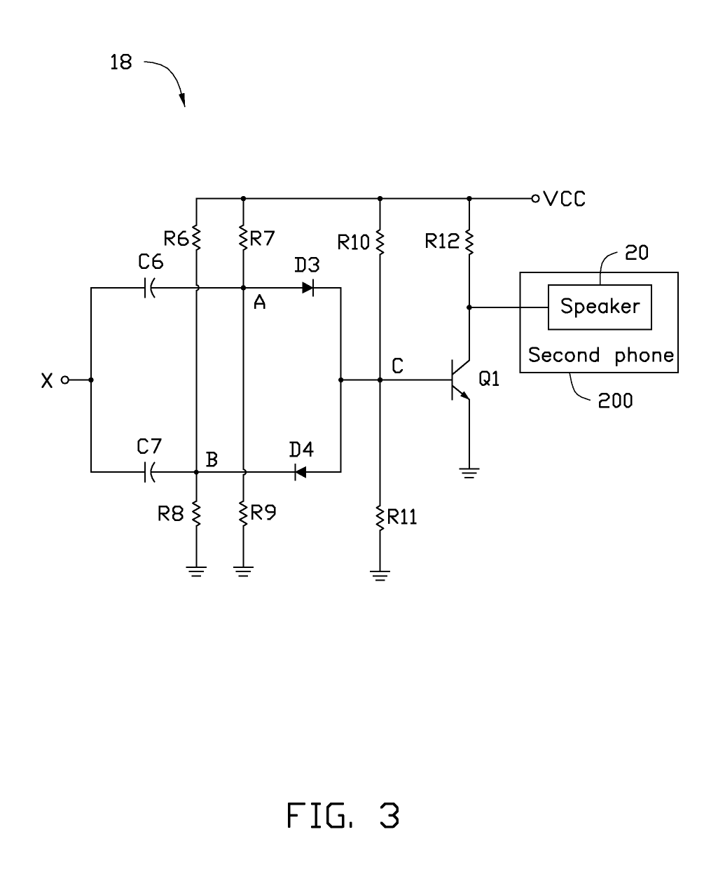

FIG. 3 shows that the processing circuit 18 includes two capacitors C6 and C7, resistors R6-R12, two diodes D3 and D4, and a bipolar junction transistor (BJT) Q1. The output terminal of the amplifier U2A is connected to a power supply VCC through the capacitor C6 and the resistor R7 in that order. The output terminal of the amplifier U2A is further grounded through the capacitor C7 and the resistor R8 in that order. A node A between the capacitor C6 and the resistor R7 is grounded through the resistor R9. A node B between the capacitor C7 and the resistor R8 is connected to the power supply VCC through the resistor R6. The node A is further connected to an anode of the diode D3. A cathode of the diode D3 is connected to an anode of the diode D4. A cathode of the diode D4 is connected to the node B.

A node C between the cathode of the diode D3 and the anode of the diode D4 is connected to the power supply VCC through the resistor R10, and further grounded through the resistor R11. A base of the BJT Q1 is connected to the node C. An emitter of the BJT Q1 is grounded. A collector of the BJT Q1 is connected to the power supply VCC through the resistor R12. The collector of the BJT Q1 further outputs the electrical signals with less noise. In the embodiment, the power supply VCC is 3.7V, and can be supplied through a battery of the phone.

In the embodiment, the frequency selection circuit 12 is an active band-pass filter circuit. According to specification of the active band-pass filter circuit, capacitances of the capacitors C1, C2, and resistances of the resistors R1-R3 can be selected, to signal the frequency selection circuit 12 to select the electrical signals corresponding to the sound signals with the frequency between 65 Hz-1.1 KHz.

In detail, a voltage on the point A is equal to VCC*(R9/(R7+R9)), a voltage on the point B is equal to VCC*(R8/(R6+R8)), and a voltage on the point C is equal to VCC*(R11/(R11+R10)). In one embodiment, the voltage of VCC is equal to 3.7V, and the resistances of the resistors R6-R11 are respectively 10 kohm, 10 kohm, 13 kohm, 31 kohm, 10 kohm, and 31 kohm. Thus, the voltages on the point A to C are respectively 2.8V, 2.1V, and 2.5V. Due to a voltage difference at two ends of the diode D3 and a voltage difference at two ends of D4 are less than 0.6 volts, thus, the diodes D3 and D4 are turned off. When the value of the amplified electrical signal received from the amplifying circuit 15 is greater than or equal to 3.1V, the diode D3 is turned on. The diode D4 is turned off. The amplified electrical signal outputted from the amplifier U2A is provided to the base of the transistor Q1 through the diode D3. The transistor Q1 is at an amplifying state. The collector of the transistor Q1 outputs the amplified electrical signal to the speaker 20 of the second phone 200. At the same time, because the diode D4 is turned off, the amplified electrical signal will not be fed back to the amplifier U2A, to avoid causing interference. When the value of the electrical signal output from the amplifier U2A is less than or equal to −3.1V, the diode D3 is turned off. The diode D4 is turned on. The amplified electrical signal outputted from the amplifier U2A is provided to the base of the transistor Q1 through the diode D4. The transistor Q1 is at an amplifying state. The collector of the transistor Q1 outputs the amplified electrical signal to the speaker 20 of the second phone 200. At the same time, because the diode D3 is turned off, the amplified electrical signal will not be fed back to the amplifier U2A, to avoid interference.

The noise suppression system 1 can select electrical signals corresponding to sound signals with the frequency between 65 Hz-1.1 KHz through the frequency selection circuit 12, amplifies the selected electrical signals through the amplifying circuit 15, and outputs the amplified electrical signals to the speaker 20 through the processing circuit 18, to obtain good sound signals in a call.

The foregoing description of the exemplary embodiments of the disclosure has been presented only for the purposes of illustration and description and is not intended to be exhaustive or to limit the disclosure to the precise forms disclosed. Many modifications and variations are possible in light of disclosure above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A noise suppression system applicable to a first phone, to filter noise received by a microphone of the first phone, wherein the microphone receives sound signals with different frequencies and converts the sound signals to electrical signals, the noise suppression system comprising:
a selection circuit to receive the electrical signals from the microphone and select special electrical signals with frequency between 65 hertz to 1.1 kilohertz from the electrical signals;
an amplifying circuit to receive the selected electrical signals from the selection circuit and amplify the selected electrical signals; and
a processing circuit to store a first preset value and a second preset value less than the first preset value, wherein the processing circuit receives the amplified electrical signals from the amplifying circuit and compares a value of each of the amplified electrical signal with the first and second preset values, when the value of the amplified electrical signal is greater than or equal to the first preset value, or the value of the amplified electrical signal is less than or equal to the second preset value, the processing circuit outputs the amplified electrical signal.

2. The noise suppression system of claim 1, wherein the selection circuit comprises first to fifth resistors, first to third capacitors, and a first amplifier, a first terminal of the first resistor is connected to the microphone, a second terminal of the first resistor is grounded through the second resistor, the second terminal of the first resistor is also connected to an inverting input terminal of the first amplifier through the first capacitor and the third resistor in that order, and connected to the inverting input terminal of the first amplifier through the second capacitor, a non-inverting input terminal of the first amplifier is grounded through the third capacitor, an output terminal of the first amplifier is connected to a node between the first capacitor and the third resistor, the output terminal of the first amplifier is also connected to the amplifying circuit, the amplifying circuit is grounded through the fourth and fifth resistors connected in series, a node between the fourth and fifth resistors is connected to the non-inverting input terminal of the first amplifier.

3. The noise suppression system of claim 2, wherein the amplifying circuit comprises a second amplifier, an inverting input terminal of the second amplifier is connected to the output terminal of the first amplifier, a non-inverting input terminal of the second amplifier is grounded through the fourth and fifth resistors in that order, an output terminal of the second amplifier is connected to the processing circuit.

4. The noise suppression system of claim 3, wherein the processing circuit comprises sixth and seventh capacitors, sixth to twelfth resistors, first and second diodes, and a bipolar junction transistor (BJT) transistor, the output terminal of the second amplifier is connected to a power source through the sixth capacitor and the sixth resistor in that order, the output terminal of the second amplifier is grounded through the seventh capacitor and the seventh resistor in that order, a node between the sixth capacitor and the sixth resistor is grounded through the eighth resistor, and connected to an anode of the first diode, a cathode of the first diode is connected to an anode of the second diode, a cathode of the second diode is connected to a node between the seventh capacitor and the seventh resistor, the cathode of the second diode is also connected to the power source through the ninth resistor, the cathode of the second diode is connected to the power source through the tenth resistor and also grounded through the eleventh resistor, a base of the BJT transistor is connected to the cathode of the first diode, an emitter of the BJT transistor is grounded, a collector of the BJT transistor is connected to the power source through the twelfth resistor and also outputs the amplified electrical signal.
